(19) United States
(12) Patent Application Publication
(10) Pub. No.: US 2026/0110410 A1
(43) Pub. Date: Apr. 23, 2026

(54) PORTABLE LIGHT

(71) Applicant: MILWAUKEE ELECTRIC TOOL CORPORATION, Brookfield, WI (US)

(72) Inventor: Brian A. Foster, Milwaukee, WI (US)

(21) Appl. No.: 19/361,635

(22) Filed: Oct. 17, 2025

Related U.S. Application Data
(60) Provisional application No. 63/708,527, filed on Oct. 17, 2024.

(51) Int. Cl. F21L 4/04; F21L 4/02; F21V 19/00; F21V 23/00; F21Y 113/00

(52) U.S. Cl. CPC F21L 4/045; F21L 4/027; F21V 19/003; F21V 23/003; F21Y 2113/30

(57) ABSTRACT

The techniques described herein relate to a portable light including a body including an elongated housing extending along a housing axis between a first end and a second end, opposite the first end, a light-emitting head including a housing portion extending along a light head axis between a first end and a second end, opposite the first end, and a joint pivotally coupling the second end of the elongated housing with the first end of the light-emitting head for rotation between a closed position, in which the light-emitting head abuts the elongated housing, and an open position, in which the light-emitting head extends from the elongated housing. The portable light further includes a first light source coupled to the light-emitting head and configured to emit visible light and a UV light positioned on the body and configured to emit UV light.

### RELATED APPLICATIONS

This application claims priority to U.S. Provisional Application No. 63/708,527, filed Oct. 17, 2024, the entire contents of which are herein incorporated by reference.

### BACKGROUND

The present technology relates to portable lights. More specifically, the technology relates to an LED-based stick light or inspection light that is powered by a DC power source.

Stick lights or inspection lights are commonly used to illuminate work areas that are otherwise difficult to light. Examples of these areas include automobile engine compartments, ceiling spaces, basement areas, and the like.

### SUMMARY

In some aspects, the techniques described herein relate to a portable light including a body including an elongated housing extending along a housing axis between a first end and a second end, opposite the first end, a light-emitting head including a housing portion extending along a light head axis between a first end and a second end, opposite the first end, and a joint pivotally coupling the second end of the elongated housing with the first end of the light-emitting head for rotation between a closed position, in which the light-emitting head abuts the elongated housing, and an open position, in which the light-emitting head extends from the elongated housing. The portable light further includes a first light source coupled to the light-emitting head and configured to emit visible light and a UV light positioned on the body and configured to emit UV light.

In some aspects, the techniques described herein relate to a portable light including a body, a first light source supported by the body, and a second light source supported by the body. The first light source includes a first plurality of LEDs and the second light source includes a second plurality of LEDs. The portable light includes a driving circuit connecting the first light source and the second light source together in an anti-parallel relationship.

In some aspects, the techniques described herein relate to a portable light including a body including an elongated housing and a light-emitting head coupled to the elongated housing. The portable light further includes a dual-sided printed circuit board (PCB) positioned within the light-emitting head, a first light source coupled to a first side of the dual-sided PCB and configured to emit light in a first direction, and a second light source coupled to a second side of the dual-sided PCB, opposite the first side, and configured to emit light in a second direction, opposite the first direction. The first light source and the second light source are connected together anti-parallel to each other.

Other aspects will become apparent by consideration of the detailed description and accompanying drawings.

### BRIEF DESCRIPTION OF THE DRAWINGS

FIG. 1 is a front perspective view of a portable light, according to some embodiments.

FIG. 2 is a rear perspective view of the portable light of FIG. 1.

FIG. 3A is a side view of the portable light of FIG. 1 in a folded position.

FIG. 3B is a side view of the portable light of FIG. 1 in an extended position.

FIG. 4 is a block diagram illustrating control circuitry for use in the portable light of FIG. 1, according to one embodiment.

FIG. 5 is a circuit diagram illustrating one embodiment of light driver circuitry for use in the portable light of FIG. 1.

FIG. 6 is a schematic side view of an exemplary circuit board in a light-emitting head of the portable light of FIG. 1.

FIG. 7 is a circuit diagram illustrating one embodiment of light source circuitry for use in the portable light of FIG. 1.

### DETAILED DESCRIPTION

Before any embodiments of the herein described technology are explained in detail, it is to be understood that the disclosed technology is not limited in its application to the details of construction and the arrangement of components set forth in the following description or illustrated in the following drawings. The technology is capable of other embodiments and of being practiced or of being carried out in various ways.

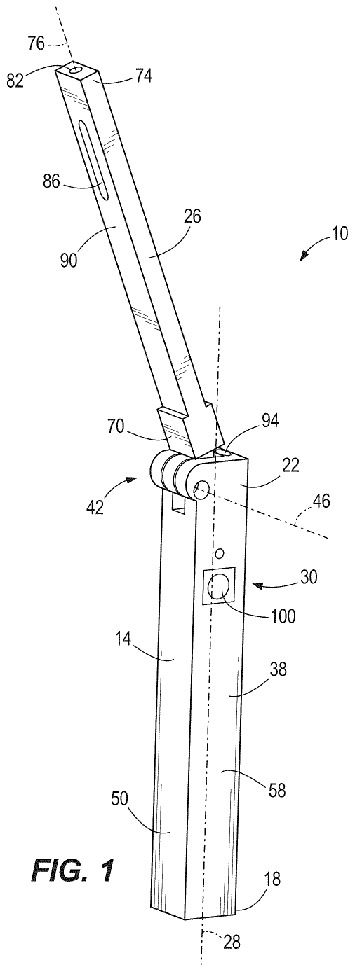

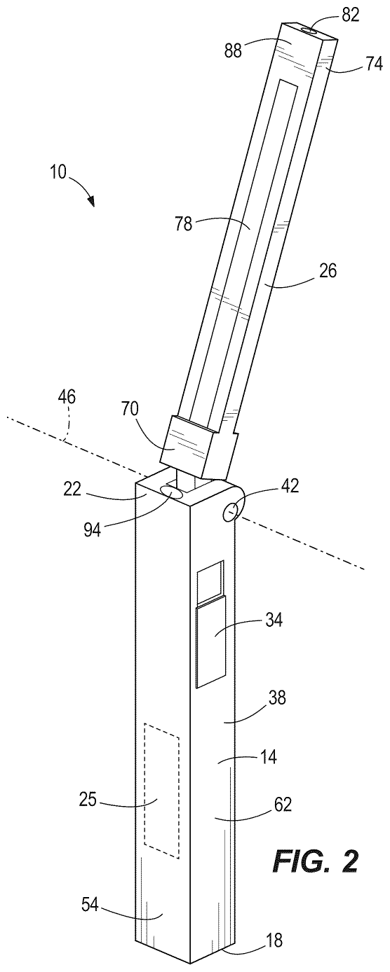

FIG. 1-3B illustrate a portable light 10, such as a stick light or inspection light. With reference to FIGS. 1 and 2, the illustrated stick light 10 is a hand-held, electrically powered light that includes an elongated housing 14 having a first end 18 and a second end 22 opposite the first end 18, and a light-emitting head 26 coupled to the second end 22 of the housing 14. A longitudinal axis 28 extends centrally through the first and second ends 18, 22 of housing 14. The housing 14 is elongated in that an overall length, or height, of the housing 14 (measured along the axis 28) is significantly greater than a width, or diameter, of the housing 14 (measured transverse to the axis 28), giving the portable light 10 a stick or tube-shaped appearance. The housing 14 includes a grip portion 38 configured to be grasped by a user to hold and carry the portable light 10. In some embodiments, a relatively soft material may be positioned or molded over at least a portion of the grip portion 38 to increase the friction between a user's hand and the grip portion 38, which improves the user's grip of the housing 14. The elongated housing 14 defines a front side 50 (FIG. 1), a rear side 54 (FIG. 2), and first and second sides 58, 62 that extend between the front and rear sides 50, 54.

The portable light 10 further includes a user interface 30 supported on the housing 14 to selectively activate the light-emitting head 26. The portable light 10 is battery powered and includes a battery cell 25 (FIG. 2) positioned in the housing 14. In the illustrated embodiment, the battery cell 25 is an internal battery, and the portable light 10 includes a charging interface 34 (FIG. 2) formed on the housing 14 and configured to provide power to the battery cell 25. In some embodiments, the charging interface 34 may include an input port, such as a USB type port, or any other set of electrical contacts capable of electrically coupling the battery cell 25 to a power source. In some embodiments, the battery cell 25 may be removably coupled to the first end 18 of the housing and may be recharged via the charging interface 34 or by removing the battery cell 25 and coupling it to an external charger. In one embodiment, the battery cell 25 is a 3-volt Lithium-Ion battery. In other embodiments, other battery sizes and chemistries may be used. In operation, the battery cell 25 selectively provides power to the light-emitting head 26 to illuminate an area based on input from the user interface 30. In some embodiments, the user interface 30 may be positioned on or adjacent the grip portion 38 such that a user holding the portable light 10 at the grip portion 38 can easily operate the light 10 with a single hand. In some embodiments, the user interface 30 and the charging interface 34 are on opposite sides of the housing 14. In the illustrated embodiment, the user interface 30 is positioned on the first side 58 and the charging interface 34 is positioned on the second side 62. In other embodiments, the user interface 30 and charging interface 34 may be positioned in other locations on the portable light 10.

With continued reference to FIGS. 1 and 2, the light-emitting head 26 includes a housing portion 66 having a first end 70, a second end 74 opposite the first end 70, and a longitudinal axis 76 extending through the first and second ends 70, 74. The first end 70 is coupled to the second end 22 of the housing 14. The housing portion 66 houses a plurality of light sources 78, 82, 86.

As seen in FIG. 2, in the illustrated embodiment, a first light source 78 is housed on a first or top surface 88 of the housing portion 66. The first light source 78 may include a plurality or array of LED lights. The first light source 78 emits visible light (i.e., light in the visible light spectrum). The first light source 78 may also be referred to as a full panel light 78. The first light source 78 is configured to provide a wide beam or a flood of light. The first light source 78 is configured to emit light in a first direction, perpendicular to the longitudinal axis 76 and generally normal to the top surface 88. In some embodiments, the first light source 78 extends along the longitudinal axis 76 for more than 50% of a length of the housing portion 66. In other embodiments, the first light source 78 may extend any length along the longitudinal axis 76. In other embodiments, the first light source 78 may have other configurations.

As seen in FIGS. 1 and 2, in the illustrated embodiment, a second light source 82 is housed on the second end 74 of the housing portion 66. The second end 74 is perpendicular to the top surface 88. The second light source 82 may include a single LED light source or a plurality of LED light sources. The second light source 82 emits visible light (i.e., light in the visible light spectrum). The second light source 82 may also be referred to as a spotlight 82. The spotlight 82 is configured to provide a focused beam along the longitudinal axis 76 of the light-emitting head 26. In other embodiments, the second light source 82 may have other configurations.

As seen in FIG. 1, in the illustrated embodiment, a third light source 86 is housed on a second or bottom surface 90 of the housing portion 66. The bottom surface 90 is opposite to the top surface 88. In the illustrated embodiment, the bottom surface 90 is also parallel to the top surface 88. The third light source 86 may include a plurality of array of LED lights. The third light source 90 emits visible light (i.e., light in the visible light spectrum). The third light source 86 may be referred to as a half panel light 86 and is configured to emit a wide beam of light in a second direction, opposite the first direction, generally normal to the bottom surface 90. The third light source 86 is smaller than the first light source 78. In some embodiments, the third light source 86 extends along the longitudinal axis 76 less than 50% of the length of the housing portion 66. In some embodiments, the third light source 86 extends about half a length of the first light source 78. In other embodiments, the third light source 86 may have other configurations.

As such, the light sources 78, 82, 86 are oriented to emit light outward from three connected sides of the housing portion 66. As mentioned above, in the illustrated embodiment, the light sources 78, 82, 86 are LED light sources. In some embodiments, the light sources 78, 82, 86 may be other types of light sources. In other embodiments, other arrangements of lights may be used. In still other embodiments, the portable light 10 may include only a subset of the light sources 78, 82, 86, such as only the first and second light sources 78, 82 or only the first and third light sources 78, 86.

With continued reference to FIGS. 1 and 2, the portable light 10 further includes a UV light 94. The UV light 94 emits UV light (i.e., light in the ultraviolet spectrum). In one embodiment, the UV light 94 is positioned on the second end 22 of the housing 14. The UV light 94 is configured to emit ultra-violet radiation. In some embodiments, the UV light may be positioned elsewhere on the housing 14. In other embodiments, the UV light 92 may be positioned on the light-emitting head 26. UV light may be especially useful in detecting materials that are reactive to UV light that are not visible in normal lighting conditions.

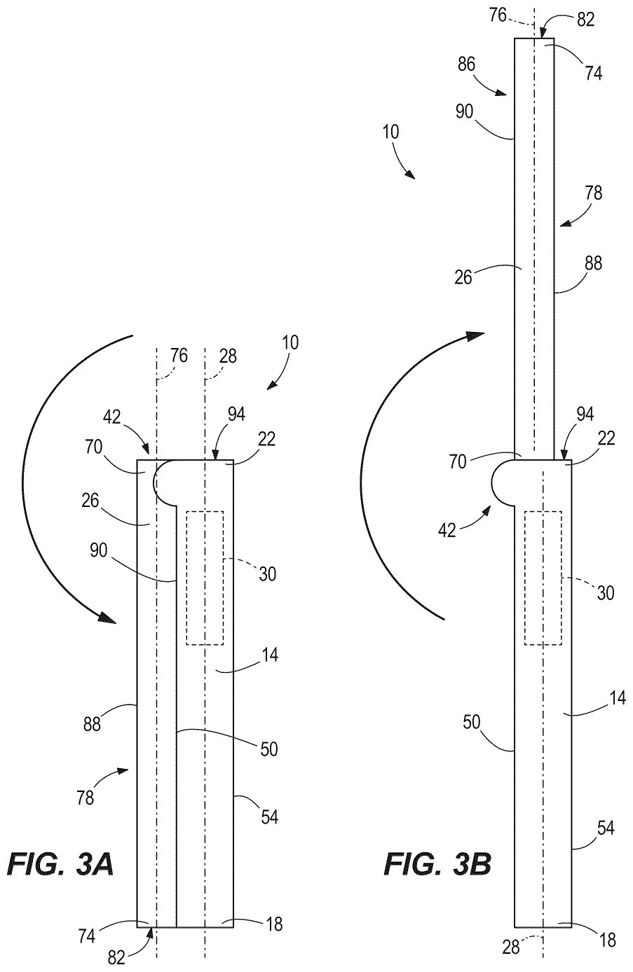

With reference to FIGS. 3A and 3B, the light-emitting head 26 is movably coupled to the housing 14 by a joint 42. Together, the housing 14, the light-emitting head 26, and the joint 42 may be considered a body of the portable light 10. In other embodiments, the body of the portable light 10 may include other components or have other configurations. In the illustrated embodiment, the light-emitting head 26 is pivotable relative to the housing 14 about a pivot axis 46 and is movable to at least a first position (FIG. 3A) and a second position (FIG. 3B). In the illustrated embodiment, the light-emitting head 26 is able to pivot freely relative to the housing 14 about the pivot axis 46 so the angle between the longitudinal axis 76 of the light emitting head 76 and the longitudinal axis 28 of the housing 14 is within a range of at least 0 degrees (FIG. 3A) to 180 degrees (FIG. 3B). The pivot axis 46 is perpendicular to the longitudinal axis 28. In some embodiments, the light-emitting head 26 may be further rotatable within a range of 0 degrees to 270 degrees, or 0 degrees to 359 degrees. The joint 42 also allows for rotation of the light-emitting head 26 relative to the housing 14 about the longitudinal axis 76 of the light-emitting head 26. The longitudinal axis 76 is perpendicular to the pivot axis 46. In some embodiments, the light-emitting head 26 may be rotated about the longitudinal axis 76 within a range of 0 degrees to 359 degrees. In some embodiments, the light-emitting head 26 may be rotated about the longitudinal axis 76 infinitely. As a result, the user can maneuver the light-emitting head 26 to a desired position during operation.

In the first position, shown in FIG. 3A, the light-emitting head 26 folds down and abuts the front side 50 of the housing 14. The first position may be referred to as a closed position, a collapsed position, or a folded position. In the first position, the longitudinal axis 76 of the light-emitting head 26 is parallel to but offset from the longitudinal axis 28 of the housing 14. The top surface 88 is exposed and thus the first light source 78 is visible and may be operated to emit light in the first transverse direction, outward from the light 10. The bottom surface 90 abuts the front side 50 of the housing 14 and thus the third light source 86 is not visible and is positioned adjacent the front face 50 of the housing 14. In other words, in the folded position, the front face 50 of the housing 14 blocks light emitted from the third light source 86 along the second transverse direction. The second end 22 is exposed and thus the UV light 94 is visible and may be operated to emit UV light along the longitudinal axis 28 in a first direction (e.g., in the direction extending from the first end 18 to the second end 22). The second end 74 of the light-emitting head 26 is exposed and thus the second light source 82 may be operated to emit light along the longitudinal axis 76 in a second direction, opposite the first direction (e.g., in the direction extending from the second end 22 to the first end 18). In the illustrated embodiment, the user interface 30 and charging interface 34 are accessible in the folded position. In other embodiments, portions of the user interface 30 and/or charging interface 34 may be positioned on the front face 50 of the housing 14 and may be inaccessible in the folded position.

In the second position, shown in FIG. 3B, the light-emitting head 26 is rotated about the pivot axis 46 away from the housing 14. The longitudinal axis 78 of the light-emitting head 26 is parallel to and generally aligned with (i.e., coaxial with) the longitudinal axis 28 of the housing 14. The second position may be referred to as an open position, an extended position, or an unfolded position. The top surface 88, the bottom surface 90, and the second end 74 are exposed. Thus, the first light 78 may be operated to emit light in the second transverse direction, the second light 82 may be operated to emit light in the first direction along the axis 28, and the third light 86 may be operated to emit light in the first transverse direction. The second end 22 of the housing 14 may be partially obscured. In some embodiments, the UV light 94 may be blocked by the first end 70 of the light-emitting head 26. In the illustrated embodiment, the UV light 94 may be visible and may still be operable to emit UV light in the first direction along the axis 28. In such an arrangement, the light-emitting head 26 is thinner than the housing 14 such that the light-emitting head 26 does not cover the entire second end 22 (and, thereby, the UV light 94) when in the open position.

During operation of the portable light 10, a user may use the portable light 10 with the light-emitting head 26 in the closed position (FIG. 3A), the open position (FIG. 3B), or a position in between (FIGS. 1 and 2). In the closed position, the portable light 10 may be used in different ways. In one example, the user may configure the light 10 in the closed position and may place the portable light 10 on a surface so the first end 18 supports the portable light 10 and may turn on the first light source 78 using the user interface 30. This allows the user to illuminate an area adjacent the portable light 10 while having both hands free. In another example, the user may configure the light 10 in the closed position and may grasp the grip portion 38 to direct the second end 22 of the portable light 10 toward an area of interest. The user may turn on the UV light 94 to illuminate and inspect the area for UV reactive materials. In another example, the user may configure the light 10 in the closed position and may grasp the grip portion 38 to direct the first end 18 of the housing 14 and second end 74 of the light-emitting head 26 toward an area of interest. The user may operate the second light source 82 to illuminate the area.

In the open position, the portable light 10 may be used in different ways. In one example, the user may configure the light 10 in the open position and may place the portable light 10 on a surface so the first end 18 supports the portable light 10. The user may operate the user interface to illuminate all of the light sources 78, 82, 86 to emit light outward from the light-emitting head 26. This allows the user to illuminate an area surrounding the portable light 10 while having both hands free. In another example, the user may configure the light 10 in the open position and may grasp the grip portion 38 to direct the second end 74 of the light-emitting head 26 toward an area of interest. The user may turn on at least the second light source 82 to illuminate the area. The portable light 10 may be used in additional ways by using one of the between positions (FIGS. 1 and 2) and by rotating the light-emitting head 26 about the axis 78.

In some embodiments, the first end 18 of the housing 24 may include an attachment member for coupling the portable light 10 to various support structures. In some examples, the attachment member may be a hook, a clip, a magnet, etc. In some examples, the attachment member may be pivotable or retractable to move between a storage position and an operation position.

The portable light 10 therefore provides portable illumination that can be easily configured to illuminate areas of interest with one or no hands.

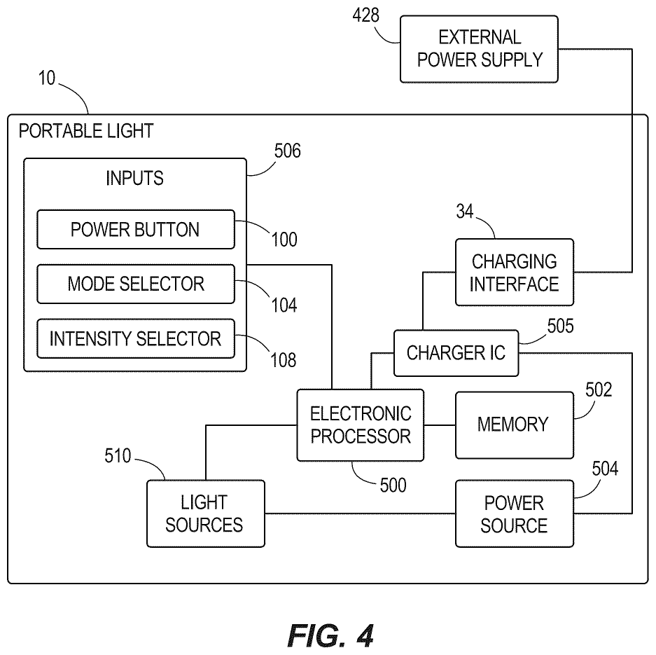

Turning now to FIG. 4, a block diagram of the portable light 10 is shown, according to one embodiment. As shown in FIG. 4, the portable light 10 includes an electronic processor 500, a memory 502, a power source 504 (e.g., the battery cell 25), one or more light sources 510 (e.g., light sources 78, 82, 86, 94), one or more inputs 506 (e.g., the user interface 30), and the charging interface 34. The electronic processor 500 is electrically coupled to a variety of components of the portable light 10 and includes electrical and electronic components that provide power, operational control, and protection to the components of the portable light 10. In some embodiments, the electronic processor 500 includes, among other things, a processing unit (e.g., a microprocessor, a microcontroller, or another suitable programmable device), a memory, input units, and output units. The processing unit of the electronic processor 500 may include, among other things, a control unit, an arithmetic logic unit (“ALU”), and registers. In some embodiments, the electronic processor 500 may be implemented as a programmable microprocessor, an application specific integrated circuit (“ASIC”), one or more field programmable gate arrays (“FPGA”), a group of processing components, or with other suitable electronic processing components.

In some embodiments, the electronic processor 500 may include a memory 502 (for example, a non-transitory, computer-readable medium) that includes one or more devices (for example, RAM, ROM, Flash memory, hard disk storage, etc.) for storing data and/or computer code for completing or facilitating the various processes, layers, and modules described herein. The memory 502 may include database components, object code components, script components, or other types of code and information for supporting the various activities and information structures described in the present application. The electronic processor 500 is configured to retrieve from the memory 502 and execute, among other things, instructions related to the control processes, algorithms, etc. The electronic processor 500 is also configured to store information on the memory 502.

In some embodiments, the power source 504 (e.g., the battery cell 25) is coupled to and transmits power to the electronic processor 500 and to one or more of the light sources 510. The power source 504 may include one or more batteries, as described above. The batteries may be removable and/or rechargeable. In some examples, the power source 504 includes other power storage devices, such as super-capacitors or ultra-capacitors. In some embodiments, the power source 504 includes combinations of active and passive components (e.g., voltage step-down controllers, voltage converters, rectifiers, filters, etc.) to regulate or control the power provided to the electronic processor 500 and/or the light sources 510.

Referring back to FIG. 1, the user interface 30 is shown schematically and includes a power button 100. The user interface 30 may also include a mode selector 104 (FIG. 4) and an intensity selector 108 (FIG. 4). The user interface 30 is electrically coupled to the battery cell 25 and the light sources 78, 82, 86 and UV light 94 through a controller and/or circuit within the housing 14 and/or light-emitting head 26 to control operation of the portable light 10. The power button 100 may be a button that is depressed or otherwise actuated by a user to turn the portable light 10 (particularly the light sources 78, 82, 86 and UV light 94) on and off. In other embodiments, the power button 100 may include a different type of user actuatable input, such as a switch, a dial, a set of buttons, etc. The mode selector 104 may be a user actuatable input of any type enabling the user to switch between different operational modes. For example, the mode selector 104 may switch between one or more of plurality of modes, including modes where 1) any single one of the light sources 78, 82, 86, 94 is illuminated, 2) multiple of the light source 78, 82, 86, 94 are illuminated, and 3) all of the light sources 78, 82, 86, 94 are illuminated. In some embodiments, certain modes may be associated with certain positions of the light-emitting head 26 relative to the housing 14. The intensity selector 108 may be a user actuatable input of any type that adjusts the intensity of the light being emitted by the light sources 78, 82, 86 (e.g., brightens or dims the light sources 78, 82, 86). In some embodiments, the UV light 94 may be a set intensity. In other embodiments, the intensity selector 108 may be used to vary the intensity of the UV light 94. In one example, the intensity selector 108 may be a button that is depressed or otherwise actuated multiple times to change the intensity of the light being emitted from a low intensity setting to a high intensity setting, or vice versa. Additionally, the mode selector 104 and intensity selector 108 may each include an indicator, such as a meter, positioned on the housing 14 to indicate to the user the current mode of the portable light 10 or the intensity level of the light being emitted. Alternately or additionally, the user interface 30 may include a display configured to emit mode, intensity, and illumination status for each of the light sources 78, 82, 86, 94. In other embodiments, other user interface configurations may be used. In some embodiments, the user interface 30 may span across multiple surfaces of the housing 14.

With reference back to FIG. 4, in one example, the electronic processor 500 is configured to detect a user actuation of one or more of the inputs 506, such as the power button 100, the mode selector 104, and/or the intensity selector 108 of the user interface 30, by detecting a change in the state of the inputs 506. Based on the detected user actuation of the mode selector 104, the electronic processor 500 determines an operational mode for the light source 510 (for example, a high output operation mode, a low output operation mode, an off mode, single light mode, multiple light mode, or the like). Similarly, in response to detecting a user actuation of the intensity selector 108, the electronic processor 500 may vary the intensity of one of more of the light sources 510. In some embodiments, the portable light 10 may only have a power button 100. The power button 100 may be a temporary push button, a slider switch, a rotating knob, etc. Accordingly, in such embodiments, the power button 100 may provide both ON/OFF inputs, as well as allow a user to select a mode. For example, a user may actuate the power button 100 a certain number of times to switch the mode of the portable light 10. In one embodiment, the user may quickly actuate and release the power button 100 to change modes (e.g., HIGH mode, MED mode, LOW mode, single light mode, multiple light mode, etc.), and actuate and hold the power button 100 to power the portable light 10 ON or OFF. Similarly, where the portable light 10 includes the mode selector 104 and the intensity selector 108, actuations of the mode selector can indicate a desired mode and actuations of the intensity selector 108 can indicate a desired light intensity of the light source 510. For example, the user may actuate the mode selector 104, which cycles through the available modes of the portable light 10 (e.g., single light source on, two light sources on, three light sources on, etc.). The user may also actuate the intensity selector 108, which cycles through the available intensity modes of the portable light 10 (e.g., HIGH mode, MED mode, and LOW mode, etc.). Based on the selected mode, as explained in more detail below, the electronic processor 500 then controls the power source 504 to provide a pulse width modulated (PWM) drive current having a predetermined duty cycle (based on a selected intensity) to the one or more light sources 510 that corresponds to the selected operational mode. In some embodiments, the portable light 10 may include a separate actuator to select each operational mode and/or intensity.

The charging interface 34 is electronically connected to the power source 504 (e.g., the battery cell 25) via a charging integrated circuit (IC) 505. The electronic processor 500 is configured to control the charging IC 505 to control power provided to the charging interface 34 from the power source 504. In some embodiments, some or all of the charging IC 505 (and functionality thereof) is integrated into the electronic processor 500.

The charging interface 34 may be electrically connected to an external power supply 428 to charge the power source 504 (e.g., the battery cell 25). In one embodiment, the external power source is a 5 VDC power supply, such as a USB connection. In other embodiments, the external power source may be a DC power source provided by a charger.

In some instances, the external power supply may be an AC utility power supply that has been converted to DC for supply to the power source 504. In the illustrated embodiment, a USB cable may be used to electrically connect the charging interface 34 to the external power supply 428.

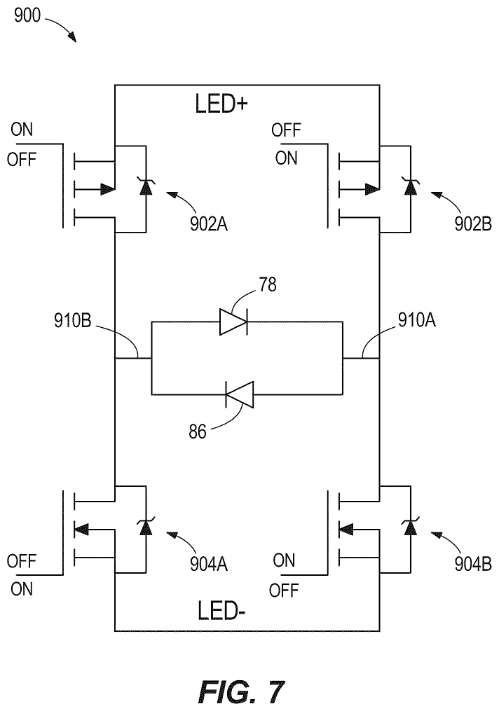

In some embodiments, one or more of the components shown in FIG. 4 may be located on one or more printed circuit boards (“PCB”) disposed in the housing 14 or the light-emitting head 26 (for example, PCB 802 of FIG. 7). In some embodiments, one or more of the components shown in FIG. 4 may be located elsewhere within or on the housing 14 of the portable light 10. In some embodiments, the portable light 10 includes additional, fewer, or different components than the components shown in FIG. 4. For example, the portable light 10 may additionally include a display to indicate an operational mode of the portable light 10. As another example, the portable light 10 may include current and/or voltage sensors that measure the current being drawn by the light source 510 (i.e., drive current) and/or the voltage of the power source 504.

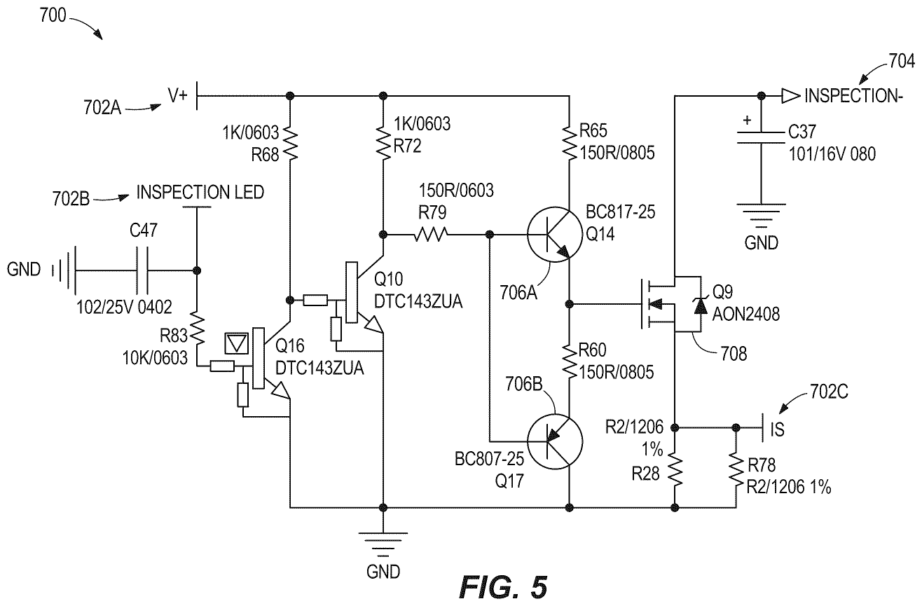

In some embodiments, the portable light 10 may include additional components. For example, in some embodiments, the charging interface 34 is coupled to, in addition to the charger IC 505, one or more of a secondary protection IC (not shown). As another example, in some embodiments the portable light 10 includes a driving circuit (described in more detail below with respect to FIG. 5) configured to provide a drive current to the light source 605 sourced from the power source 504.

In some embodiments, the portable light 10 includes a regulator (not shown), for example, a low-drop out (LDO) regulator, configured to regulate power sourced to the processor 500. In some embodiments, the charger IC 505, a secondary protection IC, or both (and functionality thereof) are integrated into the processor 500.

The charger IC 505, as described above, is configured to receive power from an external power supply (for example, the external power supply 428) when the external power supply 428 is coupled to the charging interface 34. The charger IC 505 distributes the power to one or more components of the portable light 10. For example, as illustrated in FIG. 4, the charger IC 602 provides power (via a system power line 610A) to the processor 500. In some embodiments, a regulator (not shown) may be disposed between the charger IC 505 and the processor 500 and configured to regulate the power supplied to the processor 500.

In instances where the charging interface 34 is not connected to an external power supply 428 (or the connected external power supply 428 does not supply enough power to support the components of the portable light 10), power is provided from the power source 504 to the charger IC 505 and the processor 500 (which may also be regulated via a regulator), the light sources 510, and, in some embodiments, a secondary protection IC. In some embodiments, the portable light 10 includes a step-up/boost DC to DC converter (for example, as part of the driving circuit providing the drive current to the light source 605 sourced from the power source 504).

In some embodiments, a driving circuit (not shown) of the power source 504 is configured to provide a drive current, with power sourced from the power source 504, to the at least one light source 510 based on control signals received from the electronic processor 500 to operate (based on a user input received from the power button 100 and/or the mode selector 104) and control an intensity (based on a user input received from the intensity selector 108) of one or more of the light sources 510. The power from the power source 504 is used to generate the PWM drive current output to the light sources 510, the duty cycle of which being defined by a control signal provided by the electronic processor 500 (for example, provided to the driving circuit of the power source 504).

In some embodiments, the driving circuit of the power source 504 is configured to receive a feedback signal from the light source 510 (for example, via a feedback line). The feedback signal may be utilized by the driving circuit to detect an overcurrent provided to the light source 510 from the driving circuit.

In some embodiments, a single driving circuit of the power source 504 may drive current to a single light source 510 (for example, the spotlight 82). It should be understood that, in some embodiments, the power source 504 may include one or more additional driving circuits configured to drive one or more of the other light sources 78, 82, 86, and/or 94. In some embodiments, more than one of the plurality of light sources 78, 82, 86, and 94 are driven by the same driving circuit (for example, driving circuit 700 of FIG. 5).

The particular PWM duty cycle of the drive current (defined by the control signal from the processor 500) controls the intensity of the light emitted by the light source 605. For example, for a HIGH intensity setting, the duty cycle may be approximately 56% (at approximately 19.9 kHz). As another example, for a LOW intensity setting, the duty cycle may be approximately 30% (at approximately 19.9 kHz).

In some embodiments, the driving circuit of the power source 504 includes a light emitting diode (LED) driver. Alternatively, in some embodiments the driving circuit consists of solely discrete circuit components (i.e., without IC components). FIG. 5 is an example driving circuit 700 in accordance with some embodiments. The driving circuit 700 includes a power input 702A, a control input 702B, a feedback input 702C, and a drive current output 704. In the illustrated example, the power input 702A corresponds to the power from the power source 504 and the control input 702B corresponds to the control signal received from the processor 500. The feedback input 702C corresponds the feedback signal (for example, a current sense signal) received from an output of the light source 510.

The driving circuit 700 receives power at the first input 702 from the power source 504. The power is selectively applied to one or more of the light sources 510 via the output 704 according to a PWM signal provided by the processor 500, received at the second input 702B. The drive current (and the duty cycle thereof) provided to the output 704 is controlled by a transistor pair (transistors 706A and 706B) connected at a gate terminal of the transistor 708.

In some embodiments, the driving circuit 700 provides the drive current to only one of the plurality of lighting sources (for example, the light source 82). In some embodiments, the driving circuit 700 is configured to provide the drive current to more than one of the plurality of lighting sources 78, 82, 86, and/or 94.

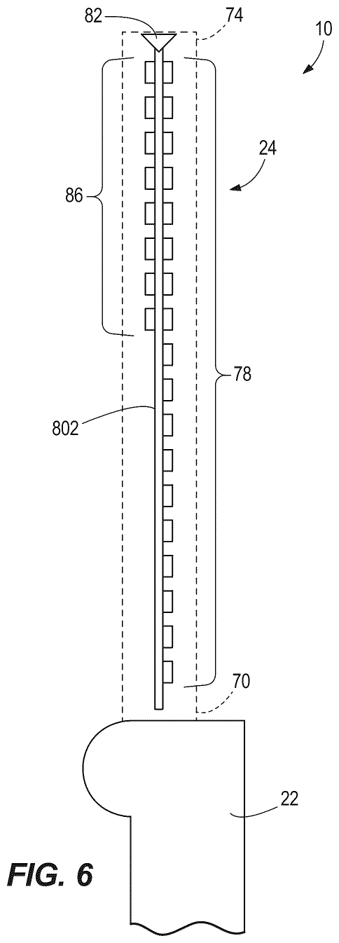

FIG. 6 is a schematic side view of an exemplary PCB 802 in the light-emitting head 26 of the portable light 10 in accordance with some embodiments. In the illustrated example, the plurality of light sources 78 and 86 are each disposed on different sides of the PCB 802. In the illustrated example, the PCB 802 is a dual-sided PCB (or double-sided PCB) configured to mount components on both sides/faces of the PCB 802. This may be more cost-effective compared to, for example, each of the plurality of light sources 78 and 86 being mounted to individual PCBs. In some embodiments, the PCB 802 is a FR-4 PCB. In some embodiments, the PCB 802 includes a heatsink.

In some embodiments, as described above, the plurality of light sources 78 and 86 each may comprise an array or plurality of LEDs. In some embodiments, the plurality of light sources 78 and 86 each includes a plurality of LEDs connected in series with each other. In some embodiments, both the plurality of light sources 78 and 86 may be connected anti-parallel (i.e., connected in parallel together by opposite polarities) together as part of the driving circuit. For example, FIG. 7 illustrates a diagram of an anti-parallel driving circuit 900 for operation of the plurality of light sources 78 and 86 (each symbolically illustrated in FIG. 7 as a single diode element). As illustrated, the circuit 900 includes two positive-side field-effect transistors (FETs) 902A and 902B and two negative-side FETs 904A and 904B. In the illustrated example, the two positive-side FETs 902A and 902B are p-channel metal oxide FETs (MOSFETs) and the two negative-side FETS 904A and 904B are n-channel MOSFETs.

The positive end of the plurality of light sources 78 is connected to the negative end of the plurality of light sources 86 at a first junction point 910A. A negative end of the plurality of light sources 78 is connected to the positive end of the plurality of light sources 86 at a second junction point 910B. A drain terminal of each of the positive-side FETs 902A and 902B and a drain terminal of each of the negative-side FETs 904A and 904B are each connected to the junction point 910A and 910B, respectively.

The FETs 902A, 902B, 904A, and 904B are controlled according to a polarity of the control signal received at their respective gate terminals (for example, a control signal received from the electronic processor 500). In a first operation state, the FETs 902A, 902B, 904A, and 904B are operated such that current flows in a first direction through a first light source of the circuit 900 (for example, the light source 78) according to a first polarity of the control signal. For example, FETs 902A and 904B are closed while FETs 902B and 904A are open. In the first operation state, the first light source 78 is activated and the second light source 86 is not activated (due to the anti-parallel configuration of the light sources with respect to each other). In a second operational state, the FETs 902A, 902B, 904A, and 904B are operated such that current flows in a second direction through the second light source of the circuit 900 (for example, the light source 86) according to a second polarity of the control signal. For example, FETs 902A and 904B are open while FETs 902B and 904A are closed. Thus, in the second operation state, the second light source 86 is activated and the first light source 78 is not activated.

In some embodiments, the UV light 94 and the spotlight 82 may additionally or alternatively driven by an anti-parallel driving circuit configured similar to the circuit 900 described above.

The anti-parallel driving circuit for driving the sources 78 and 86 may be advantageous, for example, in instances where there is limited space in which wires may be run (for example, through the joint 42 and/or between the light emitting head 26 and the second end 22).

Although the various embodiments have been described in detail with reference to certain preferred embodiments, variations and modifications exist within the scope and spirit of one or more independent aspects as described. Various features and advantages are set forth in the following claims.

What is claimed is:

1. A portable light comprising:
a body including
an elongated housing extending along a housing axis between a first end and a second end, opposite the first end,
a light-emitting head including a housing portion extending along a light head axis between a first end and a second end, opposite the first end, and
a joint pivotally coupling the second end of the elongated housing with the first end of the light-emitting head for rotation between a closed position, in which the light-emitting head abuts the elongated housing, and an open position, in which the light-emitting head extends from the elongated housing;
a first light source coupled to the light-emitting head and configured to emit visible light; and
a UV light positioned on the body and configured to emit UV light.

2. The portable light of claim 1, further comprising a second light source coupled to the light-emitting head and configured to emit visible light, wherein the first light source is coupled to a first side of the light-emitting head and configured to emit the visible light in a first direction, and wherein the second light source is coupled to a second side of the light-emitting head and configured to emit the visible light in a second direction, opposite the first direction.

3. The portable light of claim 2, further comprising a third light source coupled to the second end of the light-emitting head and configured to emit light in a third direction perpendicular to the first direction.

4. The portable light of claim 3, wherein at least one selected from a group consisting of the first light source, the second light source, and the third light source is an LED light source.

5. The portable light of claim 3, wherein the first direction and the second direction are perpendicular to the light head axis, and wherein the third direction is parallel to the light head axis.

6. The portable light of claim 1, wherein the UV light is positioned on the elongated housing.

7. The portable light of claim 6, wherein the UV light is positioned on the second end of the elongated housing and is configured to emit light in a direction parallel to the housing axis.

8. A portable light comprising:
a body;
a first light source supported by the body, the first light source including a first plurality of LEDs;
a second light source supported by the body, the second light source including a second plurality of LEDs; and
a driving circuit connecting the first light source and the second light source together in an anti-parallel relationship.

9. The portable light of claim 8, wherein the driving circuit consists of discrete components.

10. The portable light of claim 8, wherein the body includes a light-emitting head, wherein the first light source is coupled to a first side of the light-emitting head and configured to emit light in a first direction, and wherein the second light source is coupled to a second side of the light-emitting head, opposite the first side, and configured to emit light in a second direction, opposite the first direction.

11. The portable light of claim 10, further comprising a dual-sided printed circuit board (PCB) positioned within the light-emitting head, wherein the first light source and the second light source are disposed on opposite sides of the dual-sided PCB.

12. The portable light of claim 10, wherein the body also includes an elongated housing, and wherein the light-emitting head is pivotally coupled to the elongated housing.

13. The portable light of claim 8, further comprising a UV light supported by the body.

14. A portable light comprising:
a body including an elongated housing and a light-emitting head coupled to the elongated housing;
a dual-sided printed circuit board (PCB) positioned within the light-emitting head;
a first light source coupled to a first side of the dual-sided PCB and configured to emit light in a first direction; and
a second light source coupled to a second side of the dual-sided PCB, opposite the first side, and configured to emit light in a second direction, opposite the first direction, the first light source and the second light source being connected together anti-parallel to each other.

15. The portable light of claim 14, further comprising a third light source coupled to an end of the light-emitting head and configured to emit light in a third direction perpendicular to the first direction.

16. The portable light of claim 15, wherein at least one selected from a group consisting of the first light source, the second light source, and the third light source is an LED light source.

17. The portable light of claim 16, wherein the light-emitting head extends along a light head axis between a first end and a second end, opposite the first end, wherein the third light source is coupled to the second end, wherein the first direction and the second direction are perpendicular to the light head axis, and wherein the third direction is parallel to the light head axis.

18. The portable light of claim 14, further comprising a UV light positioned on the body.

19. The portable light of claim 14, wherein the first light source and the second light source are driven via a driving circuit consisting of discrete components that does not include a light-emitting diode (LED) driver integrated circuit (IC)).

20. The portable light of claim 14, wherein the light-emitting head is pivotally coupled to the elongated housing.
